(19) United States
(12) Patent Application Publication
(10) Pub. No.: US 2009/0226185 A1
(43) Pub. Date: Sep. 10, 2009

(54) FIBER OPTIC COMMUNICATIONS USING HUE BASED ENCODING

(75) Inventor: Christopher K. Karstens, Apex, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/043,332

(22) Filed: Mar. 6, 2008

(51) Int. Cl. H04B 10/04

(52) U.S. Cl. 398/190

(57) ABSTRACT

One aspect of the present invention can include a communication system that includes at least one optical fiber, a hue encoder, and a hue decoder. The optical fiber can convey digitally encoded information that has been encoded in an optical carrier wave. The hue encoder can digitally encode a set of bits of information in a single pulse of light having a characteristic hue, wherein values for the two or more bits are determined from the characteristic hue of the pulse. The hue decoder can digitally decode a set of two or more bits of information from a single pulse of light having a characteristic hue, wherein values for the set of bits are determined from the characteristic hue of the pulse.

### BACKGROUND OF THE INVENTION

The present invention relates to the field of optical communications and, more particularly, to improving fiber optic bandwidth using hue based encoding.

A fiber optic can include a glass, plastic, or other fiber designed to guide light along its length. Light is generally kept in the core of an optical fiber, which is surrounded by a material called the cladding and which is designed to trap the light in the core using an optical technique referred to as total internal reflection. In other words, the optical fiber acts as a waveguide. Data can be encoded and conveyed over a fiber optical medium within an optical carrier wave. A digital bandwidth of a fiber optic is its data rate, which is often measured in bits/second. The greater the bandwidth, the more data can be carried across an optical fiber within a fixed period of time. At present, a typical bandwidth for a single color fiber optic medium is approximately 10 Gbit/s.

One bandwidth increasing technique specific to fiber optics is often referred to as wavelength division multiplexing (WDM). WDM is a technology which multiplexes multiple carrier signals on a signal optical fiber by using different wavelengths (e.g., colors) of laser light to carry different signals. In other words, WDM is a form of frequency division multiplexing (FDM) specific to optical carrier signals conveyed across fiber optic medium. WDM takes advantage of a fact that different frequencies of light travel along an optical fiber at different speeds and that multiple colors (e.g., frequencies) can be concurrently conveyed along a single optical fiber in a non-disruptive fashion. That is, data encoded within one color does not disrupt or affect data encoded and conveyed within a different color. At present, when using WDM and three different colors (frequencies) of light concurrently, bandwidth along an optical fiber is effectively tripled. Modern WDM systems can utilize approximately 160 different non-conflicting frequencies concurrently. A bandwidth of a 160 color WDM fiber optic medium is approximately 160*10 Gbit/sec, which equals a total capacity of 1.6 Tbit/s over a single fiber optic medium.

Different variations of WDM include dense WDM (DWDM) and course WDM (CWDM). WDM, DWDM, and CWDM are based on the same concept of using multiple wavelengths of light on a single fiber, but differ from each other in the spacing of the wavelengths, the number of channels, and the ability to amplify the multiplexed signals in the optical space.

### BRIEF SUMMARY OF THE INVENTION

One aspect of the present invention can include a method, system, and computer program product for conveying information in an optical carrier wave. The method can digitally encode a set of bits of information in a single pulse of light having a characteristic hue, wherein values for the bits are determined from the characteristic hue of the pulse. For example, the characteristic hue can be defined in terms of a set of base colors of a defined color model. A value representing a relative contribution of each base color within the characteristic hue can be determined. A set of at least two bits is individually expressed by each of the base color values and the value of relative contribution of that color compared to at least one previously defined threshold. For example, if a single threshold of fifty percent contribution is established for each base color, each base color of the pulse represents a binary value. In another example, if three thresholds (one for twenty five percent, one for fifty percent, one for seventy five percent) are established for each base color, each base color can represent a value having a mathematical BASE of four. In one embodiment, the method can be used in the context of fiber optic transmissions to add hue based multiplexing to the fiber optic transmissions, effectively increasing bandwidth across the fiber optic channel.

Another aspect of the present invention can include a communication system that includes at least one optical fiber, a hue encoder, and a hue decoder. The optical fiber can convey digitally encoded information that has been encoded in an optical carrier wave. The hue encoder can digitally encode a set two or more bits of information in a single pulse of light having a characteristic hue, wherein values for the two or more bits are determined from the characteristic hue of the pulse. The hue decoder can digitally decode a set of two or more bits of information from a single pulse of light having a characteristic hue, wherein values for the set of bits are determined from the characteristic hue of the pulse.

### BRIEF DESCRIPTION OF THE SEVERAL VIEWS OF THE DRAWINGS

FIG. 1 is a schematic diagram of a system for communicating data within optical carrier signals, which uses hue based encoding to increase fiber optic bandwidth, to route communications, and/or to perform a hue based Quality of Service (QOS) function.

FIG. 2 illustrates a schematic diagram of a system of a sample configuration for encoding optical signals into distinguishable hues in accordance with an embodiment of the inventive arrangements disclosed herein.

FIG. 3 is a flow chart of a method for encoding optical signals into distinguishable hues to improve bandwidth and/or to perform hue based routing in accordance with an embodiment of the inventive arrangements disclosed herein.

### DETAILED DESCRIPTION OF THE INVENTION

The present invention describes a technique to increase bandwidth of fiber optic communications through hue based multiplexing. Conventionally, it is possible to convey digital information over optical fibers within optical carrier waves of different frequencies. WDM and other such techniques (CWDM, DWDM, etc.) permit multiple distinct and non-conflicting channels of information to exist within a single optical fiber, each associated with a distinct frequency or color. These color based channels can be concurrently used, providing a multiple of bandwidth increase over fiber optic communications involving a single color (e.g., two colors equals times two bandwidth, three colors equals times three bandwidth, etc.). In WDM based techniques, color (or frequency) is only used to establish a distinct channel. For each color, a single pulse of light is used to represent a single bit of data (either on or off, which represents a binary zero or one).

The present invention uses a single pulse of a specifically selected color to represent multiple bits of information. For example, a color scheme, such as a red-green-blue (RGB) or cyan-magenta-yellow-black (CMYK), can be used to construct any color. A constructed color includes a percentage of each primary component (e.g., a percentage of red, a percentage of green, and a percentage of blue for a RGB scheme). Different numerical divisions of each primary component can represent a “bit” of data, which can be encoded before transmission, can be transmitted over an optical fiber, and can be successfully decoded at the other end. Thus, each pulse of “color” can represent multiple bits of data. Any color scheme can be used. Any mathematical representation system based upon differences is color characteristics can be used.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

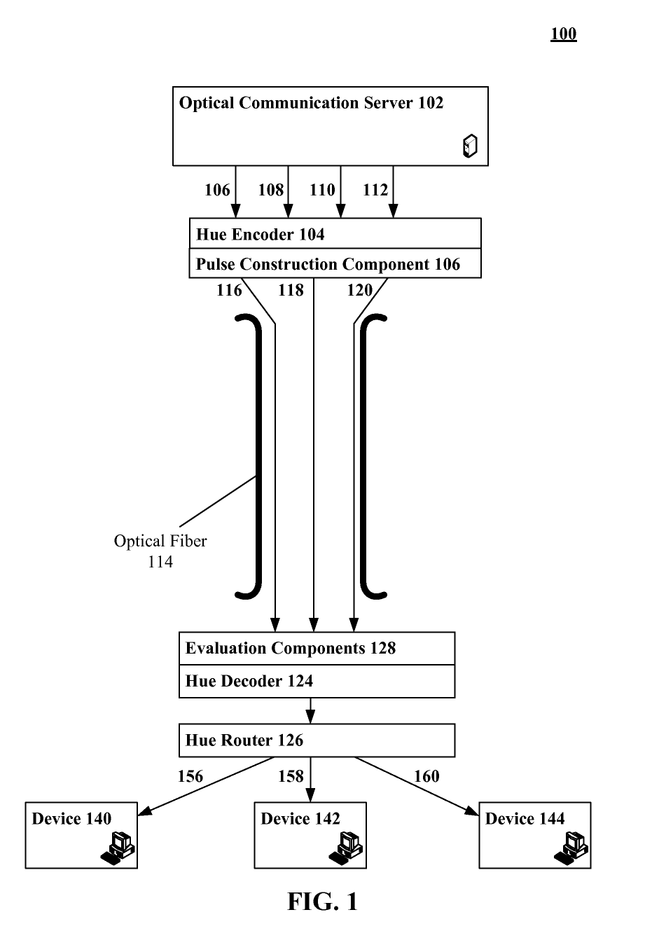

FIG. 1 is a schematic diagram of a system 100 for communicating data within optical carrier signals, which uses hue based encoding to increase fiber optic bandwidth, to route communications, and/or to perform a hue based Quality of Service (QOS) function. In system 100, optical communication server 102 can encode optical signals 106-110 using hue encoder 104. For example, the hue encoder 104 can determine a color or hue to be created for a given color scheme (e.g., RGB, CMYK, etc.). The determined color can be based upon a percentage of primary colors, which are each associated with distinct mathematical values. The determined color can be created by pulse construction components 106. Thus, a single pulse of light can represent more than just an on and an off state, but can instead represent a numerical value defined by the color scheme and mathematical encoding algorithms used by the encoder 104 (and decoder 124). The created pulse(s) can be conveyed over the optical fiber 114, where it can be received by pulse evaluation components 128, which can determine what component primary colors are included in each received pulse. These values can be decoded by decoder 124. This decoded value can be conveyed to one or more devices 140-144.

In one embodiment, multiple non-conflicting subcategories of primary colors can be established to create multiple independent “channels” within a single optical fiber 114. The channels shown in system 100, for example, include channel 116, 118, and 120. In a CMYK scheme, black (e.g., K) can be a reference color and cyan (e.g., C), magenta (e.g., M), and yellow (e.g., Y) can each represent a channel 116-120. So channel 116 can be associated with optical signals constructed from a percentage of cyan and black only; channel 118 can be associated with optical signals constructed from a percentage of magenta and black only; and channel 120 can be associated with optical signals constructed from a percentage of yellow and black only.

In one embodiment, a hue based router 126 can additionally be utilized to automatically route designated ones of the channels 116-120 to specific receiving devices 140-144. For example, using the above example, every combination of C and K (e.g., channel 116) can be routed automatically to device 140; combinations of M and K (e.g., channel 118) can be routed to device 142, and combinations of Y and K (e.g., channel 120) can be routed to device 144.

It should be emphasized that the system 100 need not establish distinct channels 116-120, but can instead use color encoding schemes based upon an entire set of primary colors of a given color scheme. In a simple example, RGB primary colors can be used by the encoder 104 and decoder 124. In this example, each primary color can have a characteristic score, where a higher score represents a stronger contribution of that color. A range of score per color can include values from zero to nine. Hence, each primary color can represent a place holding column of a BASE ten number. Thus, a red contribution in a pulse can represent a base ten one's place, a green contribution a base ten ten's place, and a blue contribution can represent a base ten's hundred's place. Accordingly, a single pulse of light can represent a set of mathematical values from 0-999.

Possible encoding/decoding combinations and ranges/scores can be dictated, at least in part, upon a sensitivity of the pulse construction components 106, the pulse evaluation components 128, and upon a transmission “purity” of the optical fiber 114. Any conceivable set of one or more color schemes, hue based mathematical algorithm, and the like can be accommodated by system 100.

As used herein, optical fiber 114 can be defined as a medium through which transmissions of information encoded within light pulses travels. The optical fiber can be constructed of numerous materials including glass, plastic wire, or fiber. More specifically, the optical fiber 114 is often a cylindrical dielectric waveguide that transmits light along its axis by the process of total internal reflection. The fiber 114 can include a core surrounding by a cladding layer. To confine the optical signal in the core, the refractive index of the core must be greater than that of the cladding. The boundary between the core and the cladding may be either abrupt (e.g., step-index fiber) or gradual (e.g., graded-index fiber). The optical fiber 114 can be a multimode fiber, a single mode fiber, and/or a special purpose fiber.

The devices 102, 140-144 can be computing devices capable of exchanging information over a network. For example, devices 102, 140-144 can include, but are not limited to, a laptop, a desktop computer, a server computer, a mobile phone, a personal data assistant (PDA), a navigation device, a communication hub, a router, a bridge, and the like.

Information exchanges among devices 102, 140-144 can occur using a client-server paradigm or a peer-to-peer one. The devices 102, 140-144 can include numerous internal components, such as a central processing unit, a persistent memory, a volatile memory, and a network interface component. Although the optical fiber 114 can be part of a communication pathway between the devices 102-140-144, portions of the pathway can include different mediums, such as copper wire, microwave frequencies of the electromagnetic (EM) spectrum, radio frequencies in the EM spectrum (e.g., WIFI, WIMAX, BLUETOOTH, etc.). A common configuration of system 100 links two geographically separated carrier central office nodes through the optical fiber 114, and uses copper lines and/or wireless communications for a last leg of delivery to a usage location, which can in turn utilize a different type of medium for intranet communications. System 100 is not limited in this regard, however, and any type of fiber optic communication is contemplated as being a candidate for bandwidth increase through hue multiplexing techniques discussed herein.

Any number of color schemes used by the hue encoder 104 and hue decoder 124, so long as encoding/decoding can be consistently performed utilizing the chosen color scheme. In one embodiment, the color scheme can be based on a set of base or primary colors, which are used to create secondary, tertiary, etc. colors. Sample color models conforming to a color scheme that are based upon base colors can include, for example, Cyan-Magenta-Yellow-Black (CMYB) based model, a Red-Green-Blue (RGB) based model, a Cyan-Magenta-Yellow (CMY) based model, a Hue-Saturation-Intensity (HSI) based model, a Luminance-In phase-Quadrature (YIQ) based model and the like. Other possible color schemes that can be utilized in system 100 include monochromatic color schemes, analogous color schemes, complementary color schemes, split-complementary color schemes, triadic color schemes, tetradic color schemes, and the like.

For example, one or more monochromatic color schemes (referring to a use of complementary colors able to be combined to produce grayscale values) can be applied where a shade of a color (or grayscale value) is used to specify an encoded value. Multiple different monochromatic color schemes can be concurrently applied to a single fiber optic 114, such as a black-white monochromatic scheme, a red-green monochromatic scheme, etc.

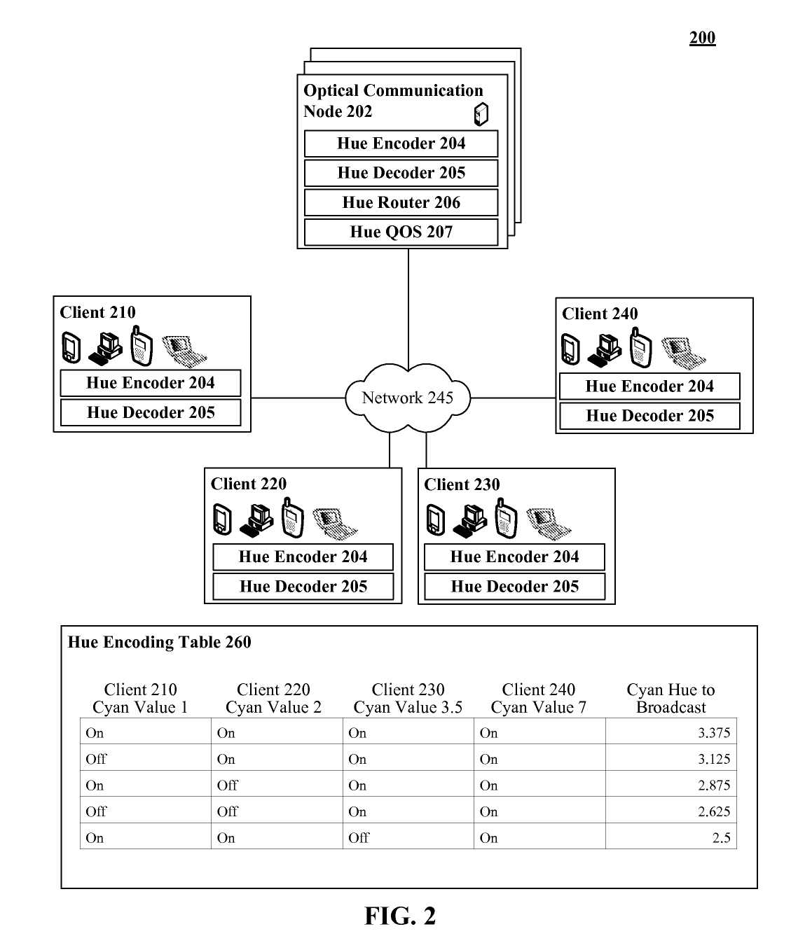

FIG. 2 illustrates a schematic diagram of a system 200 of a sample configuration for encoding optical signals into distinguishable hues in accordance with an embodiment of the inventive arrangements disclosed herein. The concepts expressed in system 100 can be applied to system 200.

In system 200, communications can be facilitated by two or more optical communication nodes 202, each including a hue encoder 204 and a hue decoder 205. Two different nodes 202 can communicate to one another using optical signals and hue based encoding as described herein. Each of the clients 210-240 can include hardware/software for exchanging data with one of the hubs 202. These client 210-240 based exchanges can occur through any medium.

In one embodiment, one or more of the clients 210-240 themselves can communicate directly with network 245 over an optical fiber medium. These clients 210-240 can include a hue encoder 204, a hue decoder 205, and other complementary hardware/software components, which together result in an ability to encode information based upon hue, which results in bandwidth gains. Point-to-point or peer-to-peer communications is possible with any of the clients 210-240 which are interconnected and which have suitable hue encoding/decoding components. Therefore, system 200 can be utilized in a client-server context, where a server or communication hub 202 is used to facilitate communications and system 200 can also be used in a direct client-to-client communication context. Further, when a single client 210-240 includes internal fiber optic waveguides to exchange among system components, hue based encoding-decoding can also apply to increase a bandwidth of component connecting fibers.

In one embodiment, in addition to using hue based encoding to increase bandwidth, one or more hue routers 206 can also be utilized. A hue router 206 can automatically route communications to target devices based upon a hue of a received optical signal. For example, client 210 can originate communications directed towards client 220, client 230, and client 240, each associated with a different optical frequency range. So communications directed towards client 220 can utilize a first optical frequency range, client 230 a second optical frequency range, and client 240 a third optical frequency range. Hub 202 can be a communication intermediary used in part to direct communications from client 210 to suitable ones of clients 220-240. When router 206 detects an optical pulse in the first frequency range, that pulse can be directed to client 220 automatically, an optical pulse in the second optical frequency range can be directed to client 230 automatically, and an optical pulse in the third optical frequency range can be directed to client 240 automatically. Hue based routing can be a very fast operation, which does not require content of an optical pulse to be decoded when determining a routing target.

In one implementation, other hue-based components (besides hue router 206) can be used to manage/control networked data without altering the data itself, meaning that the hue changes can affect a network function and the non-hue encodings can specify the data being exchanged. That is, the network components utilizing hue based networking information are not restricted to performing routing functions.

For example, one such component is a hue quality of service (QOS) component 207. The QOS component 207 can increase/decrease QOS priority for a particular client 210-240 by modifying a transmission color. The actual data packet being transmitted by the optical carrier wave is not altered, but the color of the transmitted packets for that specific data session/stream/connection are altered to indicate a QOS priority. QOS priority can be adjusted for a specific customer, a specific branch office, a specific application, an on-demand customer request, peak hour conditions, based upon semantic communication characteristics, and other variable conditions. Each of these variable conditions, if any, can be specified by metadata digitally encoded within a hue of a light pulse. For example, in one embodiment, the QOS component 207 can be configured to handle all red packets before blue packets are handled.

Appreciably, the hue based QOS functions implemented by the QOS component 207 can be implemented on top of other existing QOS/management information. For example, an operator can have QOS information embedded into the actual data packets being transmitted, while a service provider can use hue encoded QOS. Programmatic rules can establish that determine which type of QOS information takes precedent in case of conflicting information. For example, all red packets can be handled before all blue packets using hue based QOS information, while all of the red packets can be prioritized based upon the QOS data contained in the data packets.

Table 260 is shown for system 200 to illustrate a sample hue encoding/decoding example, which is based upon a relative value of Cyan within an optical pulse. The table 260 illustrates one possible hue-based scheme for performing hue based routing (using hue router 206). This scheme is intentionally different than the frequency division scheme previously illustrated to emphasize that decoding/encoding/routing can be based upon any of a variety of algorithms and color schemes. In table 260, a value of cyan within a pulse can determine where an incoming optical pulse is to be directed. A value of a single cyan pulse can determine a complete set of zero or more of the clients 210-240 that are to receive the optical pulse.

As shown, client 210 is associated with a cyan value of one, client 220 is associated with a cyan value of two, client 230 is associated with a cyan value of a three point five, and client 240 is associated with a cyan value of seven. A broadcast value in table 260 equals a sum of component values divided by a total of the clients involved in the routing (four in the example). So if an optical pulse is to be routed to each of the clients, the broadcast value equals a sum of component targets divided by four. The sum equals one (for client 210) plus two (for client 220) plus three point five (for client 230) plus seven (for client 240) or thirteen point five. The broadcast value equals thirteen point five divided by four or three point three seven five. The values for the clients 210-240 can be constructed to ensure that unique numbers for the broadcast value exist, which can be successfully and consistently encoded/decoded. It should be appreciated that table 260 only relies on a Cyan value for unique routing, so that in a Cyan-Magenta-Yellow-Black (CMYK) model, additional information (to increase bandwidth) can be encoded in values of Magenta(M), Yellow(Y), and Black(K). Thus, different schemes can be utilized to concurrently perform hue based routing and hue based bandwidth increases.

It should be appreciated that table 260 can be modified as needed to handle any hue encoding scheme based upon any associated color model used by the hue encoder 205 and hue decoder 206. For example, in one embodiment, two or more hue-based pulse values can be combined or chained together to describe a larger data unit or object. To illustrate, two CYMKGO pulses can each have a hue encoded value as shown:
a. Pulse #1=72.898
b. Pulse #2=15.381
   A chain consisting of Pulse #1 and Pulse #2 can have a value of: 7,289,815,381. That is, two or more pulses can “work together” or can be combined to represent increasing large unique numeric values, which can in-turn represent some digitally encoded value. Significant bandwidth increases can result from hue-based chaining of pulse encoded values (e.g., the above two chained pulses may, for example, represent values from 0 to 9,999,999,999).

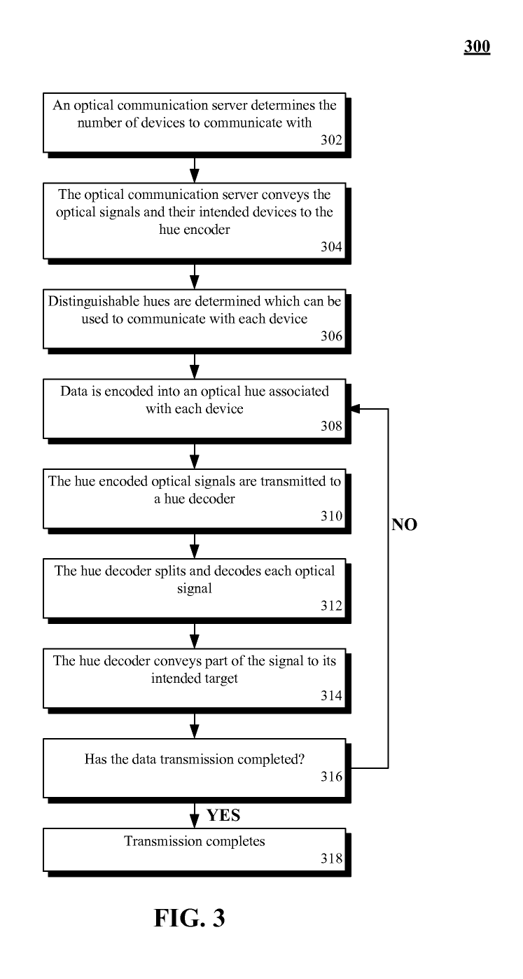

FIG. 3 is a flow chart of a method 300 for encoding optical signals into distinguishable hues to improve bandwidth and/or to perform hue based routing in accordance with an embodiment of the inventive arrangements disclosed herein. Method 300 can be performed in context of system 100 or system 200.

Method 300 can begin in step 302, where an optical communication server can determine the number of devices to communicate with. In step 304, the optical communication server can convey the optical signals and their intended devices to the hue encoder. In step 306, distinguishable hues can be determined in which can be used to differentiate each signal for conveyance with their intended devices (e.g., hue based routing). Additionally or alternatively, hue based encoding can be used to convey information unrelated to routing to intended destination devices. In step 308, data can be encoded into an optical hue as previously determined. In step 310, the hue encoded optical signals can be transmitted along an optical fiber to a destination. The destination can include a hue decoder/hue router. In step 312, the hue decoder/router can route (with or without decoding signal content depending upon implementation specifics) and/or decode content from each optical signal. In step 314, the hue decoder can optionally convey part of each signal to its set of intended targets (assuming hue based routing is performed). The conveyed signal can be conveyed along a medium other than an optical one. Additionally, the hue based routing and content decoding can occur in different steps and/or using different (possibly geographically disperse) components. In step 316, if the transmission has been completed, method 300 can continue to step 318, where the transmission can complete. In step 316, if the transmission has not completed, method 300 can loop back to step 308, where more data can be encoded into an optical hue associated with its intended device until all the data has been transmitted.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for conveying information in an optical carrier wave comprising:
digitally encoding a plurality of bits of information in a single pulse of light having a hue color, wherein values for said plurality of bits are determined from the characteristic hue of the single pulse.

2. The method of claim 1, further comprising:
defining the characteristic hue in terms of a plurality of base colors of a defined color model, wherein a value representing a relative contribution of each base color within the characteristic hue is determined, wherein a set comprising at least two bits is individually expressed by each of the base color values and the value of relative contribution of that color compared to at least one previously defined threshold.

3. The method of claim 2, wherein a number expressed by the base color value is a number written in BASE X, where the X of BASE X is equal to a number of a set of previously defined thresholds plus one, wherein said set of previously defined thresholds comprises said at least one previously defined threshold, whereby when one threshold per base color exists a number expressed by each base color is a BASE 2 (binary) number.

4. The method of claim 3, wherein the at least one previously defined threshold comprises a plurality of thresholds, whereby when two thresholds per base color exist, a number expressed by each base color is a BASE 3 number, and whereby when three thresholds per base color exist, a number expressed by each base color is a BASE 4 number.

5. The method of claim 2, further comprising:
digitally encoding a pulse value within the single pulse across a set comprising at least two of the base colors, wherein said pulse value comprises a plurality of digits, each digit of the plurality being represented by one of the at least two base colors.

6. The method of claim 5, wherein each base color has a characteristic place value in a sequence of the plurality of digits of the pulse value.

7. The method of claim 6, wherein said at least one previously defined threshold comprises a plurality of thresholds, wherein each base color represents a value written in BASE N, where the X of BASE X equals a quantity of said previously defined thresholds plus one, whereby when three base colors are used represented by digits J, K, and L respectively, a pulse value encoded in the single pulse equals a sequence of digits JKL written in BASE X.

8. The method of claim 2, wherein the color model is a color model selected from a group of color models consisting of Cyan-Magenta-Yellow-Black (CMYB) based model, a Red-Green-Blue (RGB) based model, a Cyan-Magenta-Yellow (CMY) based model, a Hue-Saturation-Intensity (HSI) based model, and a Luminance-Inphase-Quadrature (YIQ) based model.

9. The method of claim 1, wherein said single pulse of light is a first pulse of light, said method further comprising:
digitally encoding a plurality of bits of information in a second single pulse of light having a hue color, wherein values for said plurality of bits of the second single pulse are determined from the characteristic hue of the second single pulse;
chaining the plurality of bits from the first single pulse to the plurality of bits from the second single pulse to form a digitally encoded value represented by a sequence of the bits, said sequence having a quantity of bits equal to a sum of a quantity of bits associated with the first single pulse plus the quantity of bits associated with the second single pulse.

10. The method of claim 1, further comprising:
conveying said single pulse of light within an optical fiber as part of a fiber-optic communication.

11. The method of claim 1, further comprising:
routing a communication comprising said single pulse to a set comprising at least one receiving device based upon the hue color of a single pulse, wherein said single pulse of light also comprises additional information.

12. The method of claim 1, further comprising:
determining a QOS priority of a communication comprising said single pulse based upon the hue color of the single pulse, wherein said single pulse is a part of a set of one or more pulses of light, wherein said pulses of light digitally encode a data packet of information utilizing an encoding scheme independent of the hue color.

13. A communication system comprising:
at least one optical fiber configured to convey digitally encoded information that has been encoded in an optical carrier wave;
a hue encoder configured to digitally encode a plurality of bits of information in a single pulse of light having a characteristic hue, wherein values for said plurality of bits are determined from the characteristic hue of the pulse; and
a hue decoder configured to digitally decode a plurality of bits of information from a single pulse of light having a characteristic hue, wherein values for said plurality of bits are determined from the characteristic hue of the pulse

14. The system of claim 13, wherein the characteristic hue is defined in terms of a plurality of base colors of a defined color model, wherein a value representing a relative contribution of each base color within the characteristic hue is determined, wherein a set of at least two bits is individually expressed by each of the base color values and the value of relative contribution of that color compared to at least one previously defined threshold.

15. The system of claim 13, wherein the hue encoder, the hue decoder are components of a telecommunication infrastructure utilized at carrier central office locations, wherein said at least one optical fiber is part of a communication pathway between two carrier central office switches, wherein hue encoding/decoding occurs within carrier-grade interlinked telecommunication components, whereby the optical fiber connects two tandem switches, and whereby information conveyed within the optical fiber has been hue multiplexed.

16. The system of claim 13, further comprising:
a hue router configured to determine a set of receiving devices that are to be conveyed said digitally encoded information that has been encoded in the optical carrier wave based at least in part upon a hue of a single pulse of light, wherein said single pulse of light also comprises additional information.

17. The system of claim 13, further comprising:
a hue quality of service (QOS) component configured to determine a priority of the digitally encoded information that has been encoded in the optical carrier wave based at least in part upon a hue of a single pulse of light, wherein said single pulse of light also comprises additional information.

18. A computer program product for conveying information in an optical carrier wave, the computer program product comprising:
a computer usable medium having computer usable program code embodied therewith, the computer usable program code comprising:
computer usable program code configured to digitally encode a plurality of bits of information in a single pulse of light having a hue color, wherein values for said plurality of bits are determined from the characteristic hue of the pulse.

19. The computer program product of claim 18, the computer usable program code further comprising:
computer usable program code configured to define the characteristic hue in terms of a plurality of base colors of a defined color model, wherein a value representing a relative contribution of each base color within the characteristic hue is determined, wherein a set comprising at least two bits is individually expressed by each of the base color values and the value of relative contribution of that color compared to at least one previously defined threshold.

20. The computer program product of claim 18, wherein said single pulse of light is a first pulse of light, said computer program product further comprising:
computer usable program code configured to digitally encode a plurality of bits of information in a second single pulse of light having a hue color, wherein values for said plurality of bits of the second single pulse are determined from the characteristic hue of the second single pulse;
computer usable program code configured to chain the plurality of bits from the first single pulse to the plurality of bits from the second single pulse to form a digitally encoded value represented by a sequence of the bits, said sequence having a quantity of bits equal to a sum of a quantity of bits associated with the first single pulse plus the quantity of bits associated with the second single pulse.
